(19) United States
(12) Patent Application Publication
(10) Pub. No.: US 2014/0056413 A1
(43) Pub. Date: Feb. 27, 2014

(54) COMPOSITE X-RAY TRANSMISSIVE WINDOWS

(71) Applicant: Travis Lee Astle, Salt Lake City, UT (US)

(72) Inventor: Travis Lee Astle, Salt Lake City, UT (US)

(73) Assignee: VARIAN MEDICAL SYSTEMS, INC., Palo Alto, CA (US)

(21) Appl. No.: 13/594,585

(22) Filed: Aug. 24, 2012

(51) Int. Cl. H01J 35/18; G21K 1/00

(52) U.S. Cl. 378/140; 378/161

(57) ABSTRACT

Composite x-ray transmissive windows. In one example embodiment, an x-ray transmissive window is configured to be positioned in an outer housing of an x-ray device. The x-ray transmissive window includes a composite material.

### BACKGROUND

1. Field

The embodiments discussed herein relate to x-ray transmissive windows for use in x-ray devices. In particular, embodiments relate to composite x-ray transmissive windows for use in x-ray devices.

2. Relevant Technology

X-ray devices are extremely valuable tools that are used in a wide variety of applications such as industrial and medical. For example, such equipment is commonly employed in areas such as medical diagnostic examination, therapeutic radiology, semiconductor fabrication, and materials analysis.

Regardless of the applications in which they are employed, most x-ray devices operate in a similar fashion. X-rays are produced in such devices when electrons are emitted, accelerated, and then impinged upon a material of a particular composition. This process typically takes place within an x-ray tube located in the x-ray device.

One challenge encountered with the design of x-ray devices relates to x-ray transmissive windows. X-ray transmissive windows serve several, often conflicting, functions. For example, x-ray transmissive windows generally allow an x-ray beam to pass through while keeping attenuation of the x-ray beam uniform and manageable. Meanwhile, depending on the environment, certain x-ray transmissive windows may be in contact with a fluid coolant and exposed to high temperatures during normal operation of the x-ray device.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly summarized, embodiments presented herein are directed to an x-ray transmissive window for use in the outer housing of an x-ray device. In example embodiments, the x-ray transmissive window may be formed from a composite material. The composite material may apply manageable attenuation to the x-ray beam while being suited to retain fluid coolant and/or loose parts within the x-ray device following failure of an internal x-ray tube.

In one example embodiment, an x-ray transmissive window is configured to be positioned in an outer housing of an x-ray device. The x-ray transmissive window includes a composite material.

In another example embodiment, an x-ray device includes a vacuum enclosure. The vacuum enclosure is positioned within an outer housing configured to hold a volume of fluid coolant. Positioned within the vacuum enclosure are an anode and a cathode. The anode is positioned to receive electrons produced by the cathode. The x-ray device includes an x-ray transmissive window positioned in the outer housing. The x-ray transmissive window includes a fiber-reinforced composite material. The fiber-reinforced composite material includes a matrix and a fiber reinforcement positioned within the matrix.

In yet another example embodiment, an x-ray device includes a vacuum enclosure. The vacuum enclosure is positioned within an outer housing configured to hold a volume of fluid coolant. Positioned within the vacuum enclosure are an anode and a cathode. The anode is configured to produce x-rays upon receiving electrons produced by the cathode. The x-ray device also includes a detector array configured to detect x-rays produced by the anode. The x-ray device further includes an x-ray transmissive window positioned in the outer housing. The x-ray transmissive window includes a fiber-reinforced composite material. The x-ray transmissive window is configured to allow x-rays produced at the anode to pass through the fiber-reinforced composite material to the detector array. The fiber-reinforced composite material includes a matrix and a fiber reinforcement positioned within the matrix.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

### BRIEF DESCRIPTION OF THE DRAWINGS

A more particular description of the invention will be rendered by reference to specific embodiments thereof which are illustrated in the appended drawings. It is appreciated that these drawings depict only example embodiments of the invention and are therefore not to be considered limiting of its scope. These example embodiments will be described and explained with additional specificity and detail through the use of the accompanying drawings in which:

FIG. 1 is a simplified cross-section depiction of an example x-ray device incorporating an example composite x-ray transmissive window;

FIG. 2 is a depiction of one example environment in which the example x-ray device of FIG. 1 may be employed;

FIG. 3 is a perspective view of the example composite x-ray transmissive window of FIG. 1;

FIG. 4 is a perspective view of a second example composite x-ray transmissive window;

FIG. 5 is a perspective view of a third example composite x-ray transmissive window; and

FIG. 6 is a perspective view of a fourth example composite x-ray transmissive window.

### DESCRIPTION OF EMBODIMENTS

Currently, some x-ray transmissive windows of x-ray devices are typically formed from polymer materials such as polyetherimide or polycarbonate. Although rare, it is possible that an x-ray tube within an x-ray device may experience multiple-fault failure modes wherein one or more parts of the x-ray tube come into direct contact with an x-ray transmissive window of an outer housing of the x-ray device. For example, during some x-ray tube failures, a portion of an anode or a vacuum enclosure may come into contact with the x-ray transmissive window of the outer housing. Because the anode may be rotating at very high angular velocities and some parts of the x-ray tube may be at very high temperatures when the x-ray tube fails, a part having a very high temperature and/or traveling at a very high velocity may potentially come into contact with the x-ray transmissive window of the outer housing.

A high-force impact and/or high temperatures occurring during an x-ray tube failure may cause common outer housing x-ray transmissive windows to melt, break, or otherwise fail in such a manner that fluid coolant may be released from the x-ray device through the outer housing x-ray transmissive window, particularly where a polymer x-ray transmissive window is used. The release of fluid coolant, potentially at high temperatures, may pose risk of annoyance or injury, or damage objects near the x-ray device. Objects near the x-ray device may include sensitive medical equipment, valuable artifacts, or the like. Thus, it is preferable that the x-ray transmissive window withstand high impact forces and/or high temperatures such that the x-ray transmissive window resists allowing fluid coolant to leak from the x-ray device following failure of the internal x-ray tube.

Reference will now be made to figures wherein like structures will be provided with like reference designations. It is understood that the drawings are diagrammatic and schematic representations of exemplary embodiments, and are not limiting of the present invention nor are they necessarily drawn to scale.

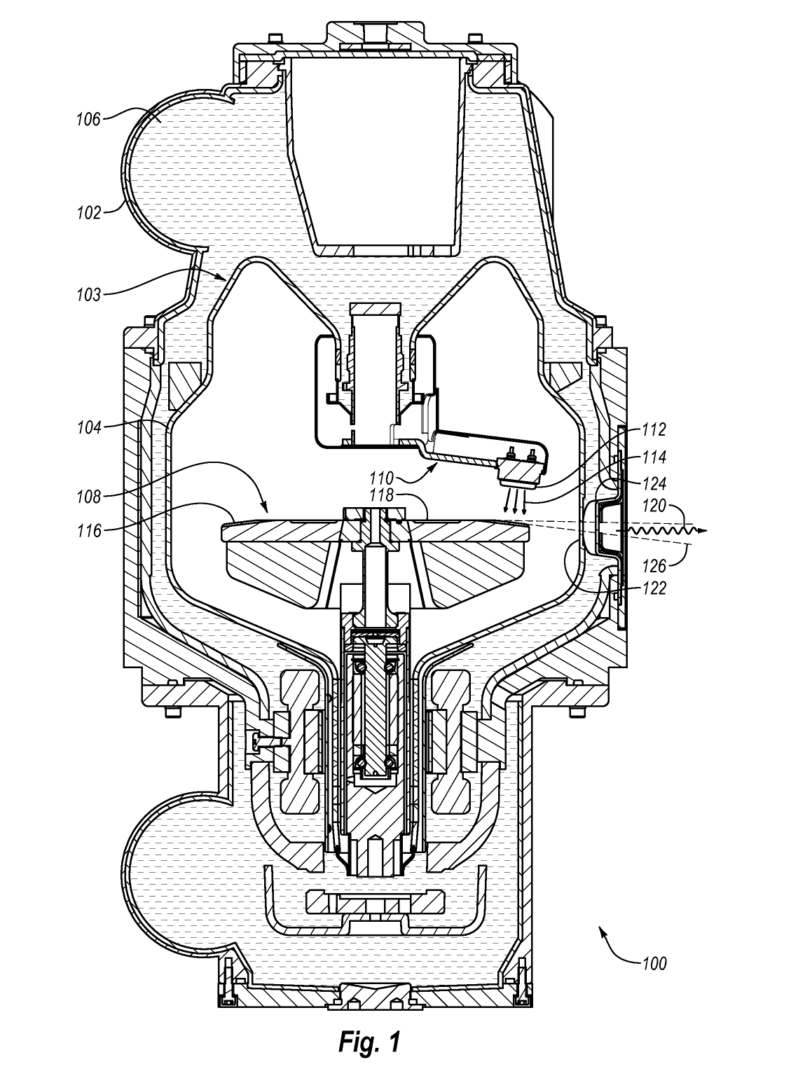

FIGS. 1-5 depict various features of example embodiments. In general, embodiments are generally directed to an x-ray transmissive window. The x-ray transmissive window may be formed from a composite material. The composite material may apply relatively low attenuation to the x-ray beam while being suited to resist high-force impacts and high temperatures such that fluid coolant and/or loose parts are retained within an x-ray device following failure of an internal x-ray tube.

As used herein, “fluid” is understood to encompass any one of a variety of substances that can be employed in cooling and/or electrically isolating an x-ray device or similar device. Examples of fluids include, but are not limited to, de-ionized water, insulating liquids, and dielectric oils.

FIG. 1 is a simplified cross-section depiction of an example x-ray device 100 incorporating a composite x-ray transmissive window 124. The x-ray device 100 includes an outer housing 102, within which is positioned an x-ray tube 103 having a vacuum enclosure 104. A fluid coolant 106 is also positioned within the outer housing 102 and circulates around the vacuum enclosure 104 to assist in x-ray device 100 cooling and to provide electrical isolation between the vacuum enclosure 104 and the outer housing 102. In one embodiment, the fluid coolant 106 comprises dielectric oil, which exhibits acceptable thermal and electrical insulating properties.

Positioned within the vacuum enclosure 104 are a rotating anode 108 and a cathode 110. The anode 108 is spaced apart from and oppositely positioned to the cathode 110, and is at least partially composed of a thermally conductive material. In some embodiments, the anode 108 is at least partially composed of tungsten or a molybdenum alloy. The anode 108 and the cathode 110 are connected within an electrical circuit that allows for the application of a high voltage potential between the anode 108 and the cathode 110. The cathode 110 includes a filament 112 that is connected to an appropriate power source, and during operation, an electrical current is passed through the filament 112 to cause electrons, designated at 114, to be emitted from the cathode 110 by thermionic emission. The application of a high voltage differential between the anode 108 and the cathode 110 causes the electrons 114 to accelerate from the filament 112 toward a focal track 116 positioned on a target surface 118 of the anode 108. The focal track 116 is typically composed of tungsten or a similar material having a high atomic (“high Z”) number. As the electrons 114 accelerate, they gain a substantial amount of kinetic energy, and upon striking the target material on the focal track 116, some of this kinetic energy is converted into electromagnetic waves of very high frequency, i.e., x-rays 120.

The focal track 116 and the target surface 118 are oriented so that emitted x-rays 120 are directed toward a vacuum enclosure window 122. The vacuum enclosure window 122 is comprised of an x-ray transmissive material and is positioned along a wall of the vacuum enclosure 104 at a location that is aligned with the focal track 116. A composite x-ray transmissive window 124, made in accordance with one embodiment, is spaced apart from and oppositely positioned to the vacuum enclosure window 122 as generally disclosed in FIG. 1.

The composite x-ray transmissive window 124 is attached in a fluid-tight arrangement to the outer housing 102 so as to enable the x-rays 120 to pass from the vacuum enclosure window 122, through the composite x-ray transmissive window 124, and exit the outer housing 102. The x-rays 120 that emanate from the vacuum enclosure 104 and pass through the composite x-ray transmissive window 124 do so substantially as a diverging beam. The path of the diverging beam that is generally used to create images is generally indicated at 126.

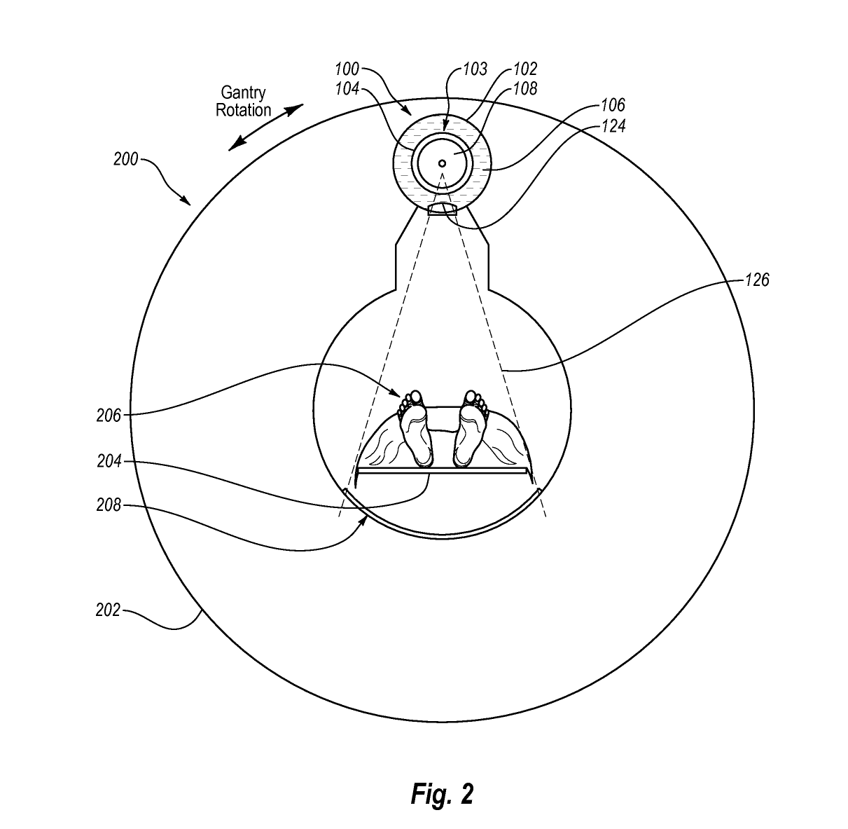

FIG. 2 is a depiction of one example environment in which the example x-ray device 100 of FIG. 1 may be employed. In particular, FIG. 2 discloses a CT scanner 200, which generally comprises a rotatable gantry 202 and a patient platform 204. The x-ray device 100 is mounted to the gantry 202 of the scanner 200. In operation, the gantry 202 rotates about a patient 206 lying on the platform 204. The x-ray device 100 is selectively energized during this rotation, thereby producing a diverging beam 126 of x-rays that emanate from the x-ray device 100. After passing through the patient, the unattenuated x-rays are received by a detector array 208. The x-rays received by the detector array 208 can be manipulated into images of internal portions of the patient 206 to be used for medical evaluation and diagnostics.

The x-ray device 100 of FIG. 2 is schematically disclosed in cross section and depicts the outer housing 102, the x-ray tube 103, the vacuum enclosure 104, and the anode 108 positioned therein, at which point the x-rays in x-ray beam 126 are produced. The x-ray device 100 further shows the example composite x-ray transmissive window 124 positioned in the outer housing 102 adjacent the fluid coolant 106. As will be seen, the composite x-ray transmissive window 124 is designed and constructed as to contain the fluid coolant 106 within the outer housing 102 following failure of the x-ray device 100.

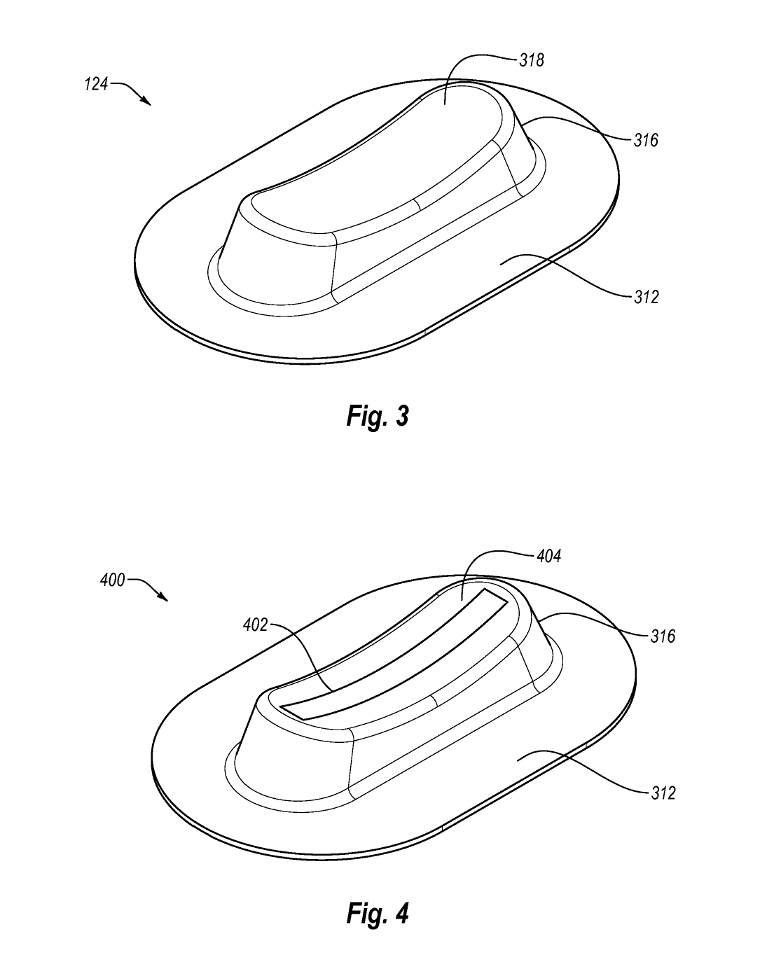

FIG. 3 is a perspective view of the example composite x-ray transmissive window 124 of FIG. 1. The composite x-ray transmissive window 124 may be formed entirely or predominately from a composite material. For example, the composite x-ray transmissive window 124 may be formed from a continuous piece of composite material. In another example, the composite x-ray transmissive window 124 may be formed from multiple layers of composite laminate stacked and formed into a composite material.

In some embodiments, the composite material may include a matrix and a fiber reinforcement positioned within the matrix. A polymer matrix may be used. Alternately, a different material, such as aluminum or ceramic may be used as the matrix. Preferably, the matrix has a high melting and/or glass transition temperature. The materials in the matrix also preferably include elements having a low atomic (“low Z”) number. Matrix materials comprised of elements having a relatively low atomic number may cause less attenuation to x-rays than materials comprising elements with higher atomic numbers.

The fiber reinforcement material may also include elements having relatively low atomic numbers. In some embodiments, the fiber reinforcement may be made primarily of elements having an atomic number below ten. The fiber reinforcement may include, or consist essentially of, carbon fiber. Alternately or additionally, the fiber reinforcement may include, or consist essentially of, para-aramid fiber. One example of a para-aramid fiber includes polyparaphenylene terephthalamide fiber. The fiber reinforcement may be dispersed within the matrix in a woven configuration. Alternately, the fiber reinforcement may be positioned within the matrix in a continuous and aligned configuration. In some embodiments, one or more layers of fiber reinforcement may be positioned within the matrix to form the composite material. Where multiple layers of fiber reinforcement are used, different layers can have different fiber orientations.

In at least some example embodiments, the fiber reinforcement and the matrix form a composite material that exhibits sufficient heat resistance at 1,300 degrees Celsius. Alternately, the composite material may exhibit a lower melting point. In at least some example embodiments, the composite material is able to withstand a maximum impact force of at least about 300 joules of kinetic energy without failing in a manner that allows fluid coolant to pass through the composite x-ray transmissive window 124. Alternately, the composite material may be able to withstand a lower maximum impact force without failing in a manner that allows fluid coolant to pass through the composite x-ray transmissive window 124.

The composite x-ray transmissive window 124 may include a flange 312. The flange 312 may allow the composite x-ray transmissive window 124 to be attached to the outer housing 102 of the x-ray device 100 (see FIGS. 1 and 2). In some embodiments, the flange 312 and the outer housing 102 may be attached to form a fluid-tight seal.

As disclosed in FIG. 3, the x-ray transmissive window 124 may also include a wall 316 connecting the flange 312 to an inner surface 318. The flange 312, wall 316, and inner surface 318 may be configured to position the inner surface 318 at a location spaced apart from and oppositely positioned to the vacuum enclosure window 122, as disclosed in FIG. 1. The inner surface 318 may be positioned relatively near to the vacuum enclosure window 122.

FIG. 4 is a perspective view of a second example composite x-ray transmissive window 400. The composite x-ray transmissive window 400 includes a sub-window 402 through which an x-ray beam (not shown) is configured to pass. The sub-window 402 may be formed from a composite material. For example, the sub-window 402 may be formed from a fiber-reinforced composite material generally corresponding to any of the composite materials of the x-ray transmissive window 124 described with reference to FIG. 3.

The remainder of the composite x-ray transmissive window 400, namely, a flange 312, a wall 316, and an inner surface 404, may be formed from a support material through which the x-ray beam is not configured to pass. Because attenuation of the x-ray beam may not be a concern for the support material, the support material may include elements with higher atomic numbers than the composite sub-window 402. As a result, a material stronger and/or less expensive than the composite material of the sub-window 402 may be used for the support material. In some embodiments, the support material may include a metal such as steel, aluminum, aluminum alloy, or the like. Alternately or additionally, another composite material may be used for the support material. For example, the support material may include a composite material having increased strength, but also increased x-ray attenuation relative to the composite sub-window 402. Alternately or additionally, the support material may include another material.

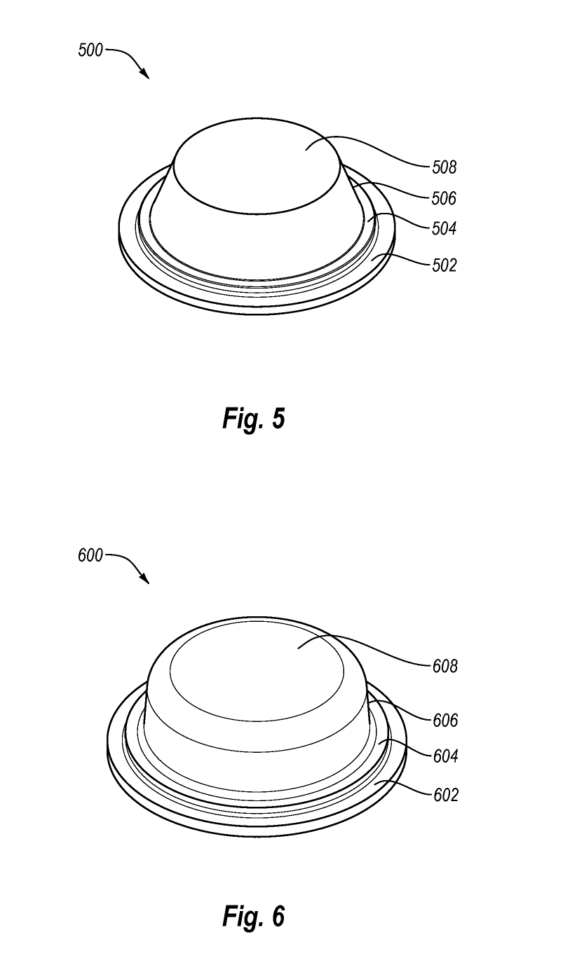

FIG. 5 is a perspective view of a third example composite x-ray transmissive window 500 according to one embodiment. The composite x-ray transmissive window 500 may include a flange 502 and a ridge 504. The flange 502 and ridge 504 may be configured to allow the composite x-ray transmissive window 500 to attach to and/or form a fluid-tight seal with an outer housing of an x-ray tube. The composite x-ray transmissive window may include a wall 506 to position an inner surface 508 at a location spaced apart from and oppositely positioned to a vacuum enclosure window of an x-ray tube (not shown). The composite x-ray transmissive window 500 may be formed from a composite material generally corresponding to any of the composite materials described with reference to the composite x-ray transmissive windows 124 and 400 of FIGS. 3 and 4.

FIG. 6 is a perspective view of a fourth example composite x-ray transmissive window 600 according to one embodiment. The composite x-ray transmissive window 600 may include a flange 602, a ridge 604, a wall 606, and an inner surface 608 generally corresponding to the flange 502, ridge 504, wall 506, and inner surface 508 of FIG. 5. However, the size and shape of the wall 606 differs from the size and shape of the wall 506 to allow the composite x-ray transmissive windows 500 and 600 to interface with different types of x-ray devices. For example the cavity formed by the walls 506 and 606 and inner surfaces 508 and 608 may be shaped to accept differently shaped beam collimators (not shown) that may be included in some x-ray devices. Similarly, the composite x-ray transmissive window 600 may be formed from a composite material generally corresponding to any of the composite materials described with reference to the composite x-ray transmissive windows 124 and 400 of FIGS. 3 and 4.

As demonstrated by the composite x-ray transmissive windows described with reference to FIGS. 1-5, the composite x-ray transmissive windows may be formed into a variety of shapes. The example composite x-ray transmissive window illustrated in FIGS. 1-5 may offer a number of advantages over an x-ray transmissive window formed from polymers, aluminum, and/or aluminum alloys. For example, the composite x-ray transmissive windows may attenuate an x-ray signal less than an aluminum and/or aluminum alloy x-ray transmissive window. At the same time, the composite x-ray transmissive windows may also significantly reduce the chance of fluid coolant escaping the outer housing through the composite x-ray transmissive window following failure of an internal x-ray tube, particularly when compared to a polymer x-ray transmissive window.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An x-ray transmissive window configured to be positioned in an outer housing of an x-ray device, the x-ray transmissive window including a composite material.

2. The x-ray transmissive window of claim 1, wherein the composite material is a fiber-reinforced composite material including:
a matrix, and
a fiber reinforcement positioned within the matrix.

3. The x-ray transmissive window of claim 2, wherein the fiber reinforcement consists essentially of elements having an atomic number below ten.

4. The x-ray transmissive window of claim 2, wherein the fiber reinforcement includes carbon fiber.

5. The x-ray transmissive window of claim 2, wherein the fiber reinforcement consists essentially of carbon fiber.

6. The x-ray transmissive window of claim 2, wherein the fiber reinforcement includes para-aramid fiber.

7. The x-ray transmissive window of claim 2, wherein the fiber reinforcement consists essentially of para-aramid fiber.

8. The x-ray transmissive window of claim 1, wherein the composite material exhibits sufficient heat resistance of at least about 1,300 degrees Celsius.

9. An x-ray device comprising:
an outer housing configured to hold a volume of fluid coolant;
the x-ray transmissive window of claim 1 positioned in the outer housing, the x-ray transmissive window configured to constrain the fluid coolant from exiting the outer housing; and
a vacuum enclosure having positioned in the outer housing and including an anode and a cathode, the anode being positioned to receive electrons produced by the cathode.

10. The x-ray device of claim 9, wherein:
the vacuum enclosure includes a vacuum enclosure window, and
the x-ray transmissive window includes:
a flange configured to secure the x-ray transmissive window to the outer housing,
a wall connected to the flange, and
an inner surface connected to the wall, the inner surface spaced apart from and oppositely positioned to the vacuum enclosure window such that an x-ray produced at the anode may through the vacuum enclosure and through the inner surface.

11. An x-ray device comprising:
a vacuum enclosure having positioned therein an anode and a cathode, the anode being positioned to receive electrons produced by the cathode;
an outer housing within which the vacuum enclosure is positioned, the outer housing configured to hold a volume of fluid coolant; and
an x-ray transmissive window positioned in the outer housing, the x-ray transmissive window including a fiber-reinforced composite material including:
a matrix, and
a fiber reinforcement positioned within the matrix.

12. The x-ray device of claim 11, wherein the fiber reinforcement consists essentially of chemical elements having an atomic number below ten.

13. The x-ray device of claim 11, wherein the fiber reinforcement includes carbon fiber.

14. The x-ray device of claim 11, wherein the fiber reinforcement consists essentially of carbon fiber.

15. The x-ray device of claim 11, wherein the fiber reinforcement includes para-aramid fiber.

16. The x-ray device of claim 11, wherein the fiber reinforcement consists essentially of para-aramid fiber.

17. The x-ray device of claim 11, wherein the composite material exhibits sufficient heat resistance of at least about 1,300 degrees Celsius.

18. The x-ray device of claim 11, wherein the x-ray transmissive window is configured to constrain the fluid coolant from exiting the outer housing.

19. The x-ray device of claim 11, wherein the vacuum enclosure includes a vacuum enclosure window, and
the x-ray transmissive window includes:
a flange configured to secure the x-ray transmissive window to the outer housing,
a wall connected to the flange, and
an inner surface connected to the wall, the inner surface spaced apart from and oppositely positioned to the vacuum enclosure window such that an x-ray produced at the anode passes through the vacuum enclosure and through the inner surface.

20. An x-ray device comprising:
a vacuum enclosure having positioned therein an anode and a cathode, the anode being configured to produce x-rays upon receiving electrons produced by the cathode;
a detector array configured to detect the x-rays produced by the anode;
an outer housing within which the vacuum enclosure is positioned, the outer housing configured to hold a volume of fluid coolant;
an x-ray transmissive window positioned in the outer housing, the x-ray transmissive window including a fiber-reinforced composite material, the x-ray transmissive window configured to allow x-rays produced at the anode to pass through the fiber-reinforced composite material to the detector array, the fiber-reinforced composite material including:
a matrix, and
a fiber reinforcement positioned within the matrix.
